(19) United States
(12) Patent Application Publication
(10) Pub. No.: US 2003/0132097 A1
(43) Pub. Date: Jul. 17, 2003

(54) Fuel-cell powered desalination device

(76) Inventors: Brian Kenet, New York, NY (US); Pedro Joaquin Sanchez Belmar, Murcia (ES)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/045,560

(22) Filed: Jan. 15, 2002

(51) Int. Cl. B01D 3/10

(52) U.S. Cl. 203/11; 203/24; 203/26; 203/1; 203/23; 203/DIG. 17; 203/DIG. 25; 202/182; 202/172; 202/205; 159/24.1; 159/44; 159/DIG. 16

(57) ABSTRACT

A desalination device includes a saltwater input line and a desalinator having a water input connected to the input line, a fresh water output and a brine output. A fuel cell generates electricity and is connected to an energy source for the desalinator. A heat exchanger transfers waste heat from the fuel cell to desalinator.

### BACKGROUND OF THE INVENTION

The present invention relates generally to water desalination devices and methods, and more particularly to desalination device amenable to being powered by renewable energy sources.

Desalination devices, such as distillation desalinators or reverse-osmosis (RO) desalinators, generally are required to operate continuously for maximum efficiency, since heat loss and other energy costs are associated with starting and stopping flow of water through the device. Moreover, in order to maximize return on capital costs, 24 hour operation of desalinators, with fresh water being stored easily in a reservoir, is generally desired.

Desalinators typically thus have been driven by generators or electric grid electricity to ensure a constant power source. Such requirements lead to limiting site placement of a desalination plant, as an electric grid or fuel supply for the generator is needed.

Fuel cell technology has been known to generate electrical power. One prominent fuel cell development recently has been with proton exchange membrane (PEM) fuel cells, which generally operate at low temperatures and are promising for automobile and other technologies. Another fuel cell technology, acid-based fuel cell technology, for example using a phosphoric acid electrolyte, generates high waste heat, of up to 180 degrees Celsius, and is thus often considered less efficient or practical than membrane fuel cell technology.

U.S. Pat. No. 5,344,722 describes for example an acid-based fuel cell technology, and is hereby incorporated by reference herein. U.S. Pat. No. 5,252,410 discloses a membrane fuel cell and is also incorporated by reference herein.

Renewable energy sources such as solar and wind power are well known, but only provide intermittent power. As a result of this problem, it has been known to store energy using an electrolyzer and the resultant hydrogen, which can then be used to run a fuel cell to provide a backup energy source.

A summary of the status of hydrogen-based storage is provided in “Hydrogen as a Storage Medium for Renewable Energy”, Spring 2000 by Magnus Korpås, of the Department of Electrical Engineering, Norwegian University of Science and Technology, which is also incorporated by reference herein.

### SUMMARY OF THE INVENTION

An object of the present invention is to provide a desalination device which can operate using a renewable energy source with high efficiency.

The present invention provides a desalination device comprising:

a saltwater input line;

a desalinator having a water input connected to the input line, a fresh water output and a brine output;

an energy source for the desalinator;

a fuel cell for generating electricity, the fuel cell being connected to the energy source; and

a heat exchanger for transferring heat from the fuel cell to the desalinator.

Preferably, the desalinator is a vapor compression desalinator having a subatmospheric evaporator. Desalinated water vapor preferably passes through at least one compressor, which heats the water vapor, and then returns through the evaporator to heat brine in the evaporator. The desalination device may be similar for example to those disclosed in co-owned and co-pending U.S. patent application Ser. No. 09/502,104 and related WO 01/58812, which are hereby incorporated by reference herein. The evaporator, i.e. boiler, of the desalinator may operate, for example, at approximately 40 to 45 degrees Celsius while the input brine, for example seawater, is typically 18 to 25 degrees Celsius. The heat exchanger preferably is located in the brine input line to raise the temperature of the input saltwater, so that heat is indirectly transferred to the desalinator. However, it may be located to directly heat the desalinator, for example by directly heating the compressed vapor return line or evaporator.

Alternately however the desalinator could be a reverse osmosis desalinator. Reverse osmosis desalinators typically require higher than ambient temperatures to provide optimal fresh water generation. When used with an RO desalinator, the heat exchanger most preferably is located in the saltwater input line.

The fuel cell preferably is a phosphoric-acid fuel cell, which operate at higher temperatures than PEM fuel cells. Although these fuel cells have been found to be less desirable than PEM fuel cells for many technologies due to their acid content and high temperatures, in the present invention the fact that the fuel cell is stationary and that waste heat is actually desired for heating the desalinator, phosphoric acid fuel cells presently are preferred. However, a PEM fuel cell, which also operates at elevated temperatures, often about 80 degrees Celsius, may alternatively be used.

The heat exchanger may be for example a tube bundle or coil surrounding the fuel cell and/or its heated water output, and may be made for example of copper tubing or other advantageous heat transfer material. The heat exchanger also may be a concentric counterflow thin film heat exchanger, for example, one similar to that commercially available from Fuel Cell Components & Integrators, Inc. A plate-type exchanger is also possible.

The fuel cell preferably is connected to a hydrogen storage tank, which is fed by an electrolyzer. The electrolyzer preferably is driven by a renewable energy source, such as a solar panel array or windmill. The hydrogen storage tank may be for example a metal hydride tank or a pressurized gas tank.

Preferably, the desalinator, if requiring electrical power, is also directly connected so to be powerable by the energy source. A part of the energy provided by the energy source thus can directly power the desalinator, which has a rated power consumption. The energy source preferably has a rated power generation during peak conditions that is at least twice the rated power consumption of the desalinator. During peak conditions, excess energy from the energy source is used to run the electrolyzer intermittently, with hydrogen generated by the electrolyzer being stored in the hydrogen storage tank.

The fuel cell preferably operates intermittently to generate electricity to run the desalinator when needed. However continuous operation is also possible.

Preferably, a power distributor receives inputs from the renewable energy source and the fuel cell, and distributes power to the desalinator and the electrolyzer. A controller is connected to the power distributor, and distributes power as a function of at least one of the rated power consumption of the desalinator and the amount of hydrogen in the storage tank. If hydrogen in the storage tank (or other energy generation variable) falls below a predetermined level, the controller can reduce the amount of saltwater fed to the desalinator and alter any other characteristics necessary for operating at the reduced amount. For example, in the vapor compression desalinator the compression of the vapor thus can be reduced, lowering the energy consumption of the compressor.

A continuous desalination process thus can result, operating on intermittent power generated from the renewable energy source.

The entire desalination device preferably is a stand-alone device, not requiring connection to an electrical power grid. A diesel generator or power generator however could be attached to provide additional power to the power distributor. If attached to the power grid, energy from the power grid for the electrolyzer preferably is provided during non-peak, less expensive hours, so that hydrogen is generated and stored using the lowest cost energy.

The present invention also provides a method for desalinating water with salts or other contaminants comprising the steps of inputting brine into a desalinator, operating a fuel cell to generate electricity and waste heat, providing the electricity to assist in operating the desalinator; and heating the desalinator using the waste heat.

Preferably, the method includes generating other electricity from a renewable energy source, and operating an electrolyzer intermittently to generate hydrogen using the renewable energy source. The hydrogen is used to power the fuel cell.

Saltwater as defined herein includes any water with salts or other contaminants that are desirable to be removed, and includes seawater, waste water, water with heavy metals, and brines. Desalination as defined herein includes any process used to remove salts or other contaminants, such as heavy metals, from saltwater.

### BRIEF DESCRIPTION OF THE DRAWINGS

A preferred embodiment of the present invention is described with reference to the following figures in which:

FIG. 1 discloses a desalination device with a vapor compression desalinator; and

FIG. 2 discloses details of one embodiment of the heat exchanger of the present invention.

### DETAILED DESCRIPTION

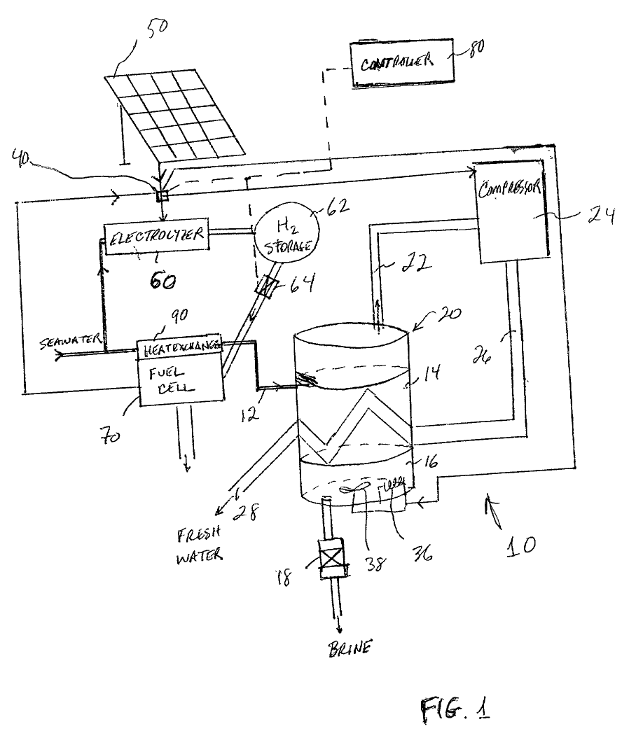

FIG. 1 shows a desalination device with a vapor compression desalinator 10. Saltwater, for example seawater, enters via an input line 12 into heat exchange section 14 of a subatmospheric evaporator 20, which for example evaporates seawater at 40 to 45 degrees Celsius. Desalinated water vapor exits the evaporator 20 through vapor line 22. The vapor is then compressed by a compressor 24, which may actually be a series of compressors. The compressor 24 preferably compresses the water vapor by at least 20 degrees Celsius to a superheated state, at which point the heated vapor passes through heated vapor line 26. Compressor 24 may be for example a positive displacement compressor manufactured by Piller Industrieventilatoren Gmbh of Moringen, Germany. Vapor line 26 passes through the heat exchange section 14, which may be for example a tube bundle evaporator/condensor, and transfers heat from the vapor line 26 to the evaporator 20. The vapor in line 26 thus condenses and is output at fresh water output 28 as desalinated water.

Seawater that does not evaporate in section 14 collects in a brine section 16 at the bottom of the evaporator 20, the brine section 16 be able to rise into the evaporator part of evaporator/condensor heat exchange section 14. A heater 36 and a stirring device 38 may be located in brine section 16, the heating device 36 being for example a heating coil to aid additional evaporation or boiling of the brine, and the stirring device 38 aiding in preventing scaling on the heat exchanger surfaces and in preventing caking or clumping of the brine. The brine can thus reach salt concentrations of 200 grams per kilogram or liter of brine or even more preferably 250 to 350 grams per kilogram or liter, and can then be centrifuged or filter pressed, so that a zero discharge system results. A valve 18 can be controlled by a controller 80 to release the brine when a desired salinity is reached. A salinity sensor can be provided in the tank and provide an input to controller 18.

Electricity for the compressor 24, heater 36 and stirrer 38 can be provided via a power distributor or switch, for example one commercially available from Siemens A G of Erlangen, Germany or Moeller GmbH of Bonn, Germany. A renewable energy source 50, for example solar panels or wind power generates electricity intermittently and feed the electricity to distributor 40. During peak conditions, for example, the energy source 50 can generate X kW of electricity. The compressor 24, for example operates normally at X/5 kW, and the heater 36 and stirrer 38 together at X/20 kW. When the energy source is generating at least X/4 kW, the distributor can for example feed X/4 kW directly to the compressor 24, heater 36, and stirrer 38. Any excess power is fed via distributor 40 to an electrolyzer 60, which can electrolyze input seawater (or other suitable water, for example fresh water output from the desalinator 20 with an electrolyte) to produce hydrogen. The hydrogen is stored in storage tank 62.

A fuel cell 70, preferably a phosphoric-acid fuel cell, receives a hydrogen input from the hydrogen tank through a valve 64. The fuel cell 70 preferably has the capacity to generate X/4 kW of power, equivalent to that needed to power the desalinator, or more, and can operate at lower power levels.

Electricity generated by fuel cell 70 is fed back to the distributor 40. Thus when power generation by the energy source 50 drops below a certain level slightly greater than X/4 kW, hydrogen is fed by opening valve 64, which can provide a variable level of hydrogen to the fuel cell 70. As the power from energy source 50 continues to drop or increases, the amount of hydrogen provided to the fuel cell 70 can be varied.

The fuel cell 70 thus outputs energy required to supplement the energy source 50 to power desalinator 10. If the energy source 50 provides no power, the fuel cell 70 operates at full power. Alternatively, the fuel cell 70 can be run continuously with energy being fed back to electrolyzer 60, which simplifies the control process of the fuel cell 70 but may lead to lower efficiencies. Depending on the operating characteristics of the fuel cell used, however, as well as of the overall design, including losses recouped at the fuel cell 70 by heat exchange, it may be desired to operate the fuel cell continuously.

Waste heat generated by the fuel cell 70 is used to heat the desalinator 10 using a heat exchanger 90, either indirectly by preheating the input saltwater or directly at the evaporator 20, for example by having a heat exchange with the brine section 16. This extra heat increases the efficiency of the desalinator, since the preheated water can be evaporated at a lower temperature in exchanger 14, or heater 36 can operate at with lower power consumption.

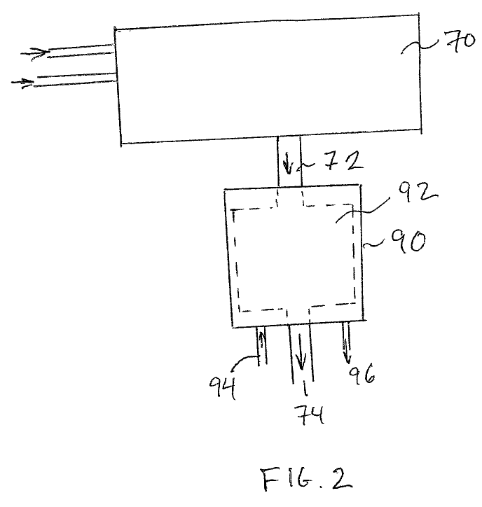

FIG. 2 shows heat exchanger 90, for example a thin film heat exchanger, that transfers heat from the heated waste water from output 72 of fuel cell 70 in a thin film area 92 to at least part of cold input water in input line 12 through an input 94. The cold water is heated and exits at output 96 before being transferred to evaporator 20. Water in input line 12 may also pass around the outside of fuel cell 70 with copper tubing or other heat transfer amenable material.

What is claimed is:

1. A desalination device comprising:
a saltwater input line;
a desalinator having a water input connected to the input line, a fresh water output and a brine output;
an energy source for providing energy to the desalinator;
a fuel cell for generating electricity, the fuel cell being connected to the energy source; and
a heat exchanger for transferring heat from the fuel cell to the desalinator.

2. The desalination device as recited in claim 1 wherein the desalinator is a vapor compression desalinator having a subatmospheric evaporator.

3. The desalination device as recited in claim 2 wherein the evaporator operates at below 50 degrees Celsius.

4. The desalination device as recited in claim 1 wherein the fuel cell is an acid-based fuel cell.

5. The desalination device as recited in claim 4 wherein the fuel cell is phosphoric acid-based fuel cell.

6. The desalination device as recited in claim 1 wherein the fuel cell outputs waste water at 80 degrees Celsius or higher.

7. The desalination device as recited in claim 1 further comprising an electrolyer and a hydrogen storage tank, the hydrogen storage tank receiving an output from the electrolyzer and providing an input to the fuel cell.

8. The desalination device as recited in claim 7 wherein the energy source is a renewable energy source, the electrolyzer being driven by the renewable energy source.

9. The desalination device as recited in claim 8 wherein the desalinator is directly powerable by the renewable energy source.

10. The desalination device as recited in claim 8 further comprising a power distributor for sending power to the electrolyzer.

11. The desalination device as recited in claim 10 wherein the desalinator has a rated maximum power consumption and the renewable energy source has a rated maximum power generation at least twice the rated maximum power consumption of the desalinator.

12. The desalination device as recited in claim 10 wherein the power distributor receives inputs from the renewable power source and the fuel cell, and provides outputs to the desalinator and the electrolyzer.

13. The desalination device as recited in claim 12 further comprising a controller receiving an input representative of a level in the hydrogen storage tank.

14. The desalination device as recited in claim 7 wherein the desalination device is a stand-alone device.

15. A method for desalinating brine comprising the steps of:
inputting water to be desalinated into a desalinator;
operating a fuel cell to generate electricity and waste heat;
providing the electricity to assist in operating the desalinator; and
heating the desalinator using the waste heat.

16. The method as recited in claim 15 further including generating other electricity from a renewable energy source, and operating an electrolyzer to generate hydrogen using the renewable energy source.

17. The method as recited in claim 16 further composing storing the hydrogen and feeding the hydrogen to the fuel cell.
